(19) United States
(12) Patent Application Publication
(10) Pub. No.: US 2007/0294146 A1
(43) Pub. Date: Dec. 20, 2007

(54) APPARATUS AND METHOD FOR OPTIMIZING INVENTORY IN A PRODUCTION OPERATION

(76) Inventors: Narayan Laksham, Cupertino, CA (US); Pushparaj Shanmugam, Santa Clara, CA (US); Rao Kota, Sunnyvale, CA (US)

Correspondence Address: IPSG, P.C., P.O. BOX 700640, SAN JOSE, CA, 95170, US

(21) Appl. No.: 11/423,119

(22) Filed: Jun. 8, 2006

(51) Int. Cl. G06Q 10/00

(52) U.S. Cl. 705/28

(57) ABSTRACT

An apparatus for analyzing inventory comprises a database configured to store historical data including inventory levels, consumption transactions, replenishment transactions, supplier lead times and prices. A computer is coupled to the database and includes procedures for retrieving data from the database, analyzing the data, and providing optimal inventory data according to a number of parameters including bins, cards, loop size, and safety stock. The computer is configured to generate at least three curves based on the historical data including actual inventory level, consumption level and optimal inventory level.

### FIELD

The present invention relates to the field of inventory and consumption analysis for optimizing inventory and cost savings in a production operation.

### BACKGROUND

In many production operations, efficient manufacturing is critical to the operation, and thus profitability, of a company. It is important to have an adequate supply of product to the end customer, and it is also important to have as little inventory as possible in the manufacturing facility. In the manufacturing process itself, it is highly beneficial to keep the amount of raw material and work-in-progress (WIP) to a minimum. The lower amount of inventory results in more efficient manufacturing by helping reduce the amount of inventory which is tied up in a manufacturing line, and also to help the flow of the manufacturing operation by not having a large amount of WIP sitting idle at any particular manufacturing step. Reduced WIP also results in reduced costs associated with the inventory that is being manufactured, as well as helps reduce the overall cycle time of an operation.

However, it is also important that any particular process step in the manufacturing line does not run out of material to process. If a process step runs out of material to process, the process step may remain idle for a period of time, thus decreasing the efficiency of the entire manufacturing operation. Furthermore, it is often common in a manufacturing operation to have a specific process or manufacturing step which is a bottleneck. That is, the remaining processes or manufacturing steps within the manufacturing operation operate faster, or have a higher production rate, than the bottleneck step. Thus, the overall output of the manufacturing operation is limited by the bottleneck. Accordingly, if a bottleneck operation is idle, the total output of the manufacturing operation may be reduced. As a result, it is common for an operation to also have a certain amount of safety stock, which may be used to help ensure that manufacturing steps do not become idle as a result of normal variances in other steps within the manufacturing operation.

In many flow production operations, a kanban type system is employed. In a kanban system, as is known in the art, a consumer pulls raw material from a producer. The producer does not produce material until given a command to do so by the consumer and this command is generated only when the consumer actually consumes material. In a kanban model, inventory is placed in bins, and each bin has an associated card. When a consumer depletes the inventory in a bin, the consumer returns the card to the producer. When the producer receives the card, it produces enough material to fill the bin. Accordingly, a producer only produces based on a demand from the consumer.

Traditionally, the size of a bin, and the number of bins used between a supplier and consumer, has been set according to empirical data associated with the operations, or by trial and error. Unfortunately, empirical data and trial and error is not an accurate way to evaluate and optimize inventory. In any case, it may be desirable to know how much of the inventory is needed by the kanban system to run efficiently, and how much of the inventory is needed to handle manufacturing process variances. Given such information, a user may decide if it is worthwhile to attempt to improve the system by removing variances or by improving performance.

Others have applied kanban techniques to inventory management. One example is U.S. Pat. No. 6,643,556, which describes a method for optimizing a supply chain consumption operation, incorporated herein by reference. Another example is U.S. Pub. No. 2004/0153187, which describes systems and methods for improving planning, scheduling, and supply chain management, incorporated herein by reference. However, these conventional systems do not adequately analyze historical data to assist the production facility in optimizing the inventory in a Kanban environment.

### SUMMARY

The present invention advantageously provides an apparatus and method for analyzing inventory in a production environment. The invention analyzes historical data to develop an optimized historical inventory level. The production management can then use the historical data in setting inventory levels for present and future production.

An exemplary embodiment of the an apparatus for analyzing inventory comprises a database configured to store historical data including bins, bin size and cards, and including bins and cards supplied, consumed and kept in inventory. A computer is coupled to the database and includes procedures for retrieving data from the database, analyzing the data, and providing optimal inventory data according to a number of parameters including bins, cards, loop size, and safety stock. The computer is configured to generate at least three curves based on the historical data including actual inventory level, consumption level and optimal inventory level.

In one aspect, the database is configured to store data including hypothetical parameters, which affect the historical data, and the computer is configured to generate a curve based on the historical data and the hypothetical parameters.

In one aspect, the computer is configured to generate a curve showing savings based on a difference between the actual inventory level and the optimal inventory level.

In one aspect, the computer is configured to generate optimal inventory level data for future forecasting.

Advantages of the invention include the ability to determine optimal inventory levels for historical data and determine potential savings by adopting an optimal inventory, and for use in future forecasting.

### DESCRIPTION OF THE DRAWINGS

The foregoing and other features, aspects, and advantages will become more apparent from the following detailed description when read in conjunction with the following drawings.

FIG. 1 depicts an exemplary architecture of the invention according to an embodiment of the invention.

FIG. 2 depicts exemplary curves of historical data according to an embodiment of the invention.

FIG. 3 depicts exemplary curves of historical data along with an optimal inventory curve according to an embodiment of the invention.

FIG. 4 is a flowchart showing a method according to an embodiment of the invention.

FIG. 5 is a flowchart showing a method according to an embodiment of the invention.

### GLOSSARY

Bin—a bin represents a lot of material. Although historically a bin referred to a physical tub or container, today it is a generic concept that can represent an individual component, a box, pallet, or container.

Bin Size—bin size represents a quantity of an item in a bin.

Card—a card is a representation of a bin or a request for a new bin's worth of material.

Loop Size—loop size is the recommended number of bins on-order and on-hand between a consumer and its supplier.

Lot Size—lot size is equivalent to bin size.

Safety Stock—safety stock is a number of bins desired to be kept in inventory or on-hand to ensure a low probability of stock out.

Stock-out—stock-out is when the inventory on hand in not sufficient to meet consumption.

### DETAILED DESCRIPTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

Further, embodiments of the invention may be described with reference to specific architectures and protocols. Those skilled in the art will recognize that the description is for illustration and to provide the best mode of practicing the invention. The description is not meant to be limiting. For example, while reference is made to a computer, any type of computer may be used in the invention. Likewise, while reference is made to certain database fields and entries, these may be modified with good results.

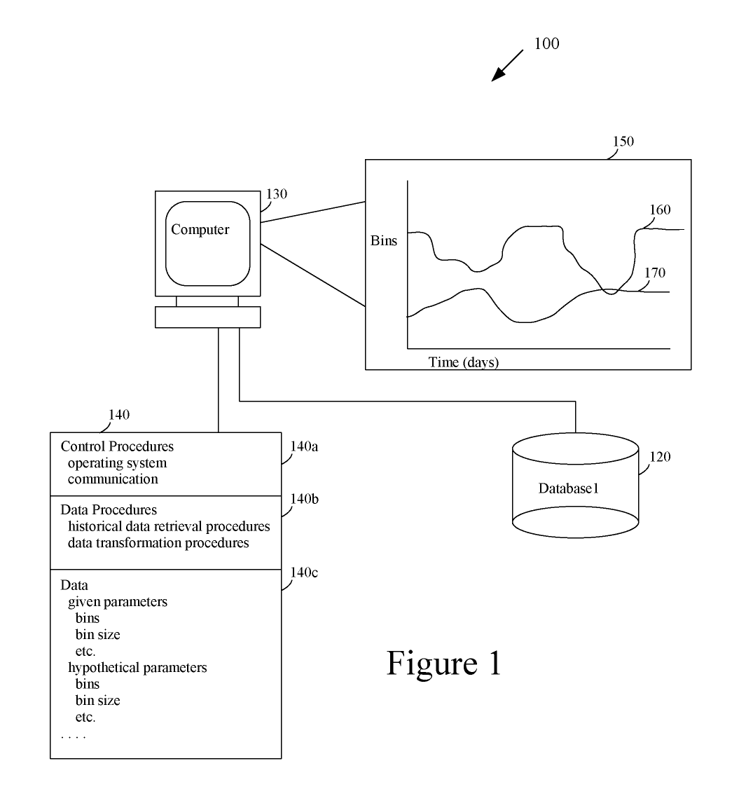

FIG. 1 depicts an exemplary architecture 100 of the invention. A database 120 is provided to store historical data including bins, bin size and cards, and including bins and cards supplied, consumed and kept in inventory.

A computer 130 is coupled to the database and includes procedures for retrieving data from the database, analyzing the data, and providing optimal inventory data according to a number of parameters including bins, cards, loop size, and safety stock. This data may often be available in an Enterprise Resource Planning (ERP) or Materials Requirements Planning (MRN) systems. ERP and MRN systems are designed primarily for schedule or forecast based manufacturing and plant-wide optimization and is not suited for evaluating granular historical data to perform inventory analysis.

The data from an ERP or MRP system is retrieved and stored in the database 120. In some cases, the data is mapped in order to code particular transactions. Examples of this mapping include: Consumption, Replenishment, Consumption Adjustment, Replenishment Adjustment, or Ignore Transaction.

The data is then analyzed to determine historical inventory levels and the consumption levels. Once these levels are determined over time (e.g. days) then the computer generates curves representing plots of the data over the desired time. In one aspect, the computer is configured to generate curves based on the historical data including actual inventory level and consumption level.

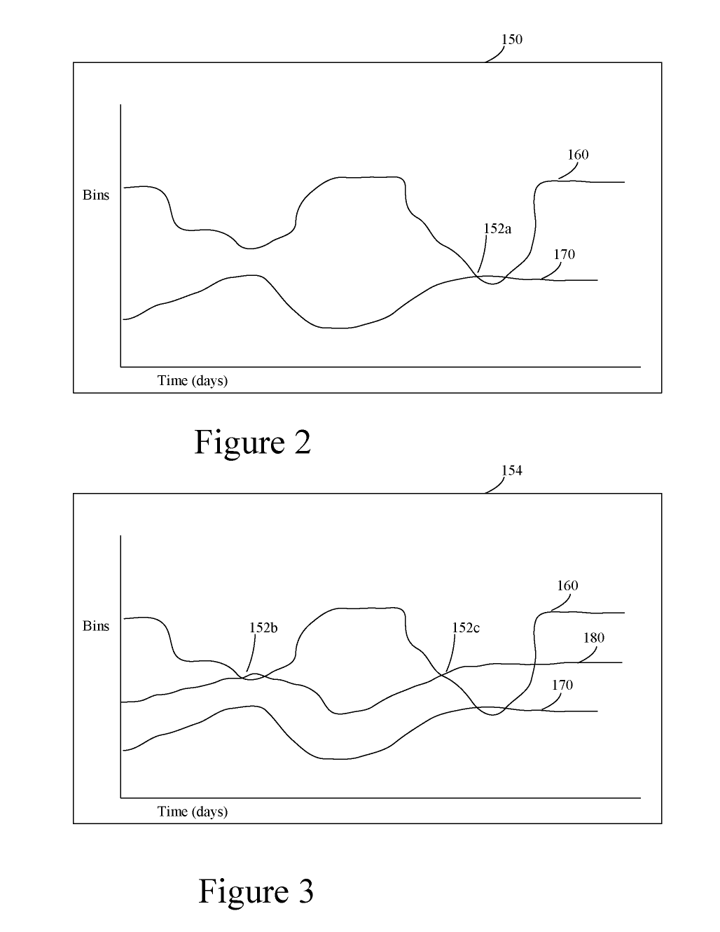

FIG. 2 depicts an exemplary display 150 showing an inventory curve 160 and a consumption curve 170. These curves represent historical data according to an embodiment of the invention. Note that at point 152a the inventory curve falls nearly to the consumption curve representing a near stock-out situation.

FIG. 3 depicts exemplary curves of historical data along with an optimal inventory curve according to an embodiment of the invention. In one aspect, the computer is configured to generate at least three curves based on the historical data including actual inventory level 160, consumption level 170 and optimal inventory level 180. Note that the optimal inventory curve is safely above the consumption curve at all times. This ensures that there are no stock outs, and the space between the curves represents a safety stock level ensuring that spikes in consumption do not result in stock outs. Note points 152b and 152c where the optimal inventory level is greater than the actual inventory level and that at other points, the optimal inventory level is less than the actual inventory level. Those portions of the display 154 where the actual inventory exceeds the optimal inventory represent areas where the company had more inventory than necessary to meet their production objectives. The invention provides the company with information related to savings that could have been achieved if their inventory level had been optimized according to the invention.

An advantage of the invention is that it uses real world historical data to provide a company with empirical information regarding inventory levels. Conventional systems employ trial and error or guesswork to determine inventory levels. By employing real world data, the invention can generate the optimal inventory curve for a company that is useful for the company to calculate savings that they could experience when employing optimal inventory levels.

In one aspect, the safety stock level for consumption (SSc) is calculated based on a number of parameters including lead time (LT), standard deviation of consumption (StdC) and a confidence constant (Z). As the term is employed herein, safety stock is a constant value that is set and maintained for extended periods of time. Safety stock may be reset once daily usage rates, the standard deviation of daily usage rates or lead times increase or decrease. An exemplary formula for this calculation is as follows.

SSc=Z*StdC*(LT)^{1/2}

The formulas and discussions above may be better understood in view of the following example involving a fictitious manufacturer of electric motors that produces many different kinds of motors for different customers. One of the component parts that the manufacturer buys from a supplier is the casing for the motor. If the supplier's lead time is three weeks and manufacturer uses an average of 100 units per day, then the manufacturer will want to have enough material on-hand to cover three weeks of usage (100*21 days=2,100 casings). The 2,100 casings will cover the average usage, but would not cover the manufacturer if they had, for example, a spike in orders from their customer.

In an embodiment, in order to decide how much safety stock to carry, the manufacturer would measure the variability in past usage (StdC) and then decide on a target service level. Assuming for example that the standard deviation in demand is equal to 200. If the manufacturer wants to be sure that they will have sufficient material to support customer orders 98% of the time, then assuming a normal distribution in material usage, the confidence constant should equal 2 times the standard deviation in consumption. Based on these parameters, the amount of safety stock required is equal to 1,833 units (2*200*(21)^{1/2}, bringing the target on-hand to 2,100 plus 1,833 or 3,933 units. This calculation assumes that the supplier's lead time is always 21 days. Additional safety stock is required to cover situations where the supplier is late in delivering material, as will be discussed herein below.

In another aspect, the safety stock level for lead time (SSlt) is calculated based on a number of parameters including standard deviation of lead time (Stdlt) and a confidence constant (Z). An exemplary formula for this calculation is as follows.

SSlt=Z*Stdlt

Extending on the example motor manufacturer above, if the variability or standard deviation in the supplier's lead time is equal to 3 days, then an additional safety stock of 6 days (2*3) or 600 units (6 days*100 units per day) will be required, this brings the total on-target inventory to 4,533 units.

Note that Stdlt represents data that is available over time in, for example, a Kanban environment. Such data would not have been obtainable from a traditional ERP system because ERP style replenishment is typically not based on standard lead times with standard lot sizes. Instead ERP style replenishment tends to be based on discrete orders, with each order having a specific quantity and delivery date. Since both the quantity and requested lead time can vary, it is impossible to measure the supplier's standard lead time. Without this standardization, the supplier's response time or lead becomes variable; varying by order and as result measuring the variability in lead time is meaningless.

In one aspect of the invention, the value Z varies between 1 and 4 where a higher level indicates a greater confidence value. This assumes that material usage varies according to a normal distribution. As such, a confidence value of 1 provides an 84% confidence level, a value of 2 provides a 98% confidence level and a value of 4 provides a 100% confidence level.

Accordingly, these parameters are included in the hypothetical parameters that can be modified and analyzed by the invention to develop an optimal inventory level curve.

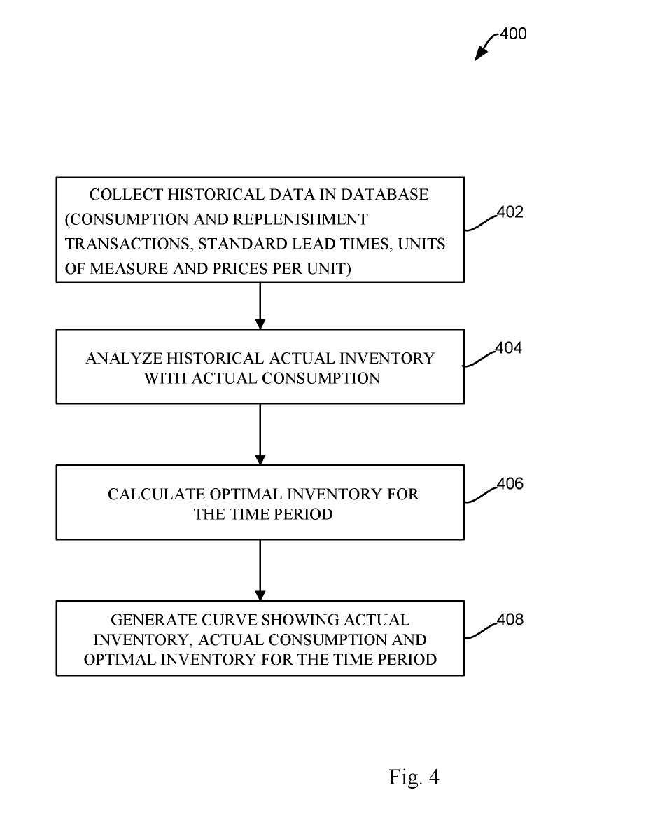

FIG. 4 is a flowchart 400 showing a method according to an embodiment of the invention. Step 402 collects historical data regarding a production operation including the number of bins, bin size, cards, actual inventory, and actual consumption levels over a particular time. Step 404 analyzes the historical data regarding actual inventory and actual consumption with the given parameters of bins, bin size, etc. Step 406 calculates an optimal inventory level for the time period based on the given parameters. Step 408 generates curves showing actual inventory, actual consumption and optimal inventory for the time period, similar to that shown in FIG. 3.

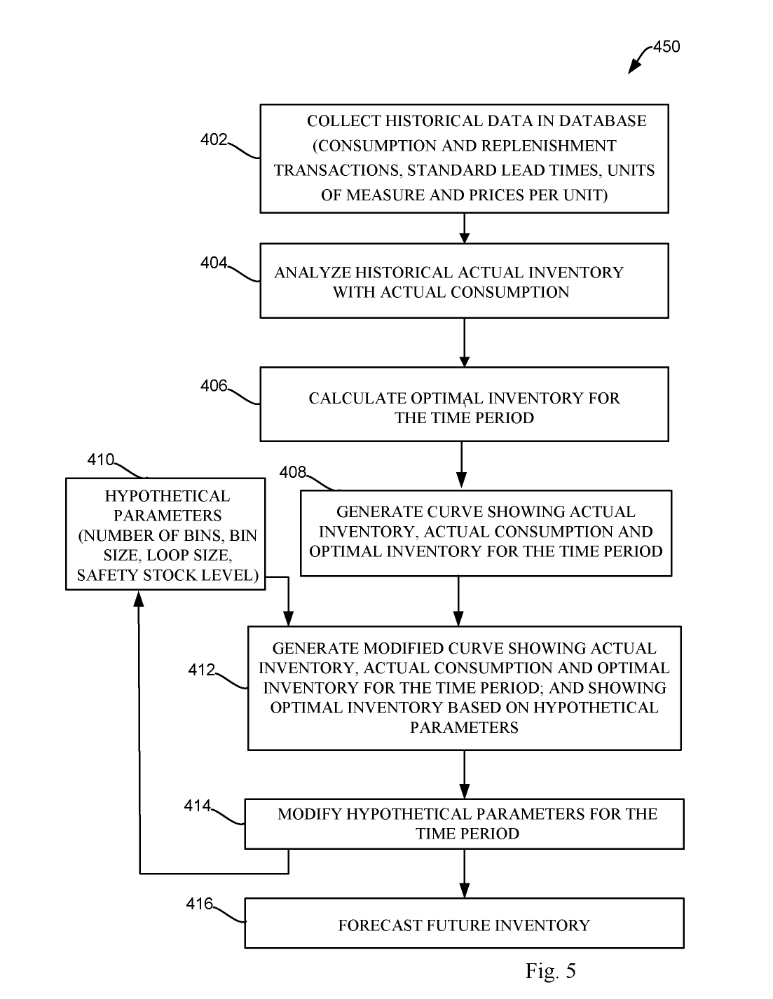

FIG. 5 is a flowchart 450 showing a method according to an embodiment of the invention. In addition to the steps described with reference to flowchart 400, flowchart 450 provides for hypothetical parameters to be introduced into the optimization to develop flexible inventory strategies for the company. Step 410 stores hypothetical parameters that can be modified by a company to determine how changes in their operations would affect inventory and potential cost savings. Exemplary parameters that can be modified include the bins, bin size, loop size, safety stock level and more. Step 412 generates modified curves showing actual inventory, actual consumption and optimal inventory based on the hypothetical parameters. Step 414 permits the company to modify the hypothetical parameters and iteratively assess the optimal inventory levels based on the hypothetical parameters. Step 416 provides forecasting for the company to determine future inventory levels based on the historical data and hypothetical parameters.

The invention supports companies to take advantage of non-normal consumption patterns to identify variations in inventory and consumption. These variations can assist the company in its future inventory forecasts based on variable parameters. They can also help the company when investigating a new or alternate supplier for goods or services relating to a particular product or service. For example, if usage for a particular part does not follow a normal distribution, the standard safety stock calculation might be too high or too low. Embodiments of the invention allow users to test out alternate safety stock levels to determine whether a lower safety stock level will still ensure minimal stock-out. As another example, if too many stock-outs are calculated using the standard safety stock, users can test out higher safety stock levels to see what level of safety stock results in an acceptable level of safety stock. Returning to our electric motor manufacturer example above, if the company is considering an overseas supplier for its motor casings, they can enter in new lead time and standard deviation in lead time figures to determine how much extra inventory they must carry to cover for the longer lead time of the overseas supplier.

Advantages of the invention include the ability to determine optimal inventory levels for historical data and determine potential savings by adopting an optimal inventory, and for use in future forecasting.

While this invention has been described in terms of several preferred embodiments, there are alterations, permutations, and equivalents which fall within the scope of this invention. It should also be noted that there are many alternative ways of implementing the methods and apparatuses of the present invention. For example, although it is contemplated that the steps of FIGS. 4 and 5 may be executed by a single computer, it is possible to employ a client-server network or other types of computer and/or data storage networks to accomplish the task of analyzing inventory in accordance with embodiments of the invention. It is therefore intended that the following appended claims be interpreted as including all such alterations, permutations, and equivalents as fall within the true spirit and scope of the present invention.

1. An apparatus for analyzing inventory, comprising:
a database configured to store historical data including bins, bin size and cards, and including bins and cards supplied, consumed and kept in inventory;
a computer coupled to the database and including procedures for retrieving data from the database, analyzing the data, and providing optimal inventory data according to a number of parameters including bins, cards, loop size, and safety stock; and
wherein the computer is configured to generate at least three curves based on the historical data including actual inventory level, consumption level and optimal inventory level.

2. The apparatus of claim 1, wherein the database is configured to store data including hypothetical parameters, which affect the historical data, and wherein the computer is configured to generate a curve based on the historical data and the hypothetical parameters.

3. The apparatus of claim 1, wherein the computer is configured to generate a curve showing savings based on a difference between the actual inventory level and the optimal inventory level.

4. The apparatus of claim 2, wherein the computer is configured to generate a curve showing savings based on a difference between the actual inventory level and the optimal inventory level.

5. The apparatus of claim 1, wherein the computer is configured to generate optimal inventory level data for future forecasting.

6. The apparatus of claim 2, wherein the computer is configured to generate optimal inventory level data for future forecasting.

7. The apparatus of claim 3, wherein the computer is configured to generate optimal inventory level data for future forecasting.

8. The apparatus of claim 4, wherein the computer is configured to generate optimal inventory level data for future forecasting.

9. A computer-implemented method of for analyzing inventory, comprising the computer-implemented steps of:
storing historical data including bins and cards supplied, consumed and kept in inventory;
retrieving data from the database, analyzing the data, and providing optimal inventory data according to a number of parameters including bins, cards, loop size, and safety stock; and
generating at least three curves based on the historical data including actual inventory level, consumption level and optimal inventory level.

10. The method of claim 9, further comprising the steps of storing data including hypothetical parameters, which affect the historical data; and
generating curves based on the historical data and the hypothetical parameters.

11. The method of claim 9, further comprising the step of generating a curve showing savings based on a difference between the actual inventory level and the optimal inventory level.

12. The method of claim 10, further comprising the step of generating a curve showing savings based on a difference between the actual inventory level and the optimal inventory level.

13. The method of claim 9, further comprising the step of generating optimal inventory level data for future forecasting.

14. The method of claim 10, further comprising the step of generating optimal inventory level data for future forecasting.

15. The method of claim 11, further comprising the step of generating optimal inventory level data for future forecasting.

16. The method of claim 12, further comprising the step of generating optimal inventory level data for future forecasting.

17. An article of manufacture comprising a program storage medium having computer readable code embodied therein, said computer readable code being configured for analyzing inventory, comprising:
computer readable code for storing historical data including bins and cards supplied, consumed and kept in inventory;
computer readable code for retrieving data from the database, analyzing the data, and providing optimal inventory data according to a number of parameters including bins, cards, loop size, and safety stock; and
computer readable code for generating at least three curves based on the historical data including actual inventory level, consumption level and optimal inventory level.

18. The article of manufacture of claim 17, further comprising computer readable code for storing data including hypothetical parameters, which affect the historical data; and
computer readable code for generating curves based on the historical data and the hypothetical parameters.

19. The article of manufacture of claim 17, further comprising computer readable code for generating a curve showing savings based on a difference between the actual inventory level and the optimal inventory level.

20. The article of manufacture of claim 18, further comprising computer readable code for generating a curve showing savings based on a difference between the actual inventory level and the optimal inventory level.
